(19) United States
(12) Patent Application Publication
(10) Pub. No.: US 2015/0199072 A1
(43) Pub. Date: Jul. 16, 2015

(54) INFRA-RED TOUCH-DETECTION AND TOUCH-RECOGNITION DEVICE

(71) Applicant: SHENZHEN WAVE MULTIMEDIA CO., LTD, Baoan Area Shenzhen (CN)

(72) Inventor: Shaolin Zhang, Shenzhen (CN)

(21) Appl. No.: 14/594,630

(22) Filed: Jan. 12, 2015

(30) Foreign Application Priority Data
Jan. 10, 2014 (IT) MI2014A000026

(51) Int. Cl. G06F 3/042; G06F 1/16

(52) U.S. Cl. CPC G06F 3/0428; G06F 1/1637

(57) ABSTRACT

Device of the type comprising a frame partially open on one of the planar surfaces, kept closed by a display module in association with an annular ornamental crown, which carries within infra-red electronic components for touch detection, characterised in that said infrared, touch-detection electronic components consist of an infra-red card, provided along the upper perimeter surface with receiving and emitting LED lamps and with separate guiding means of the infra-red light arranged vertically, said guiding means consisting of a lower guiding frame of the infra-red light and with an upper guiding frame of the infra-red light.

### FIELD OF THE INVENTION

The present invention relates to an infra-red touch-detection and touch-recognition device having improved touch detection provided for a mobile device.

### BACKGROUND ART

Infra-red display-touch-detection devices for mobile devices such as telephones, tablets, etc. are known in the art.

Infra-red technology is based on the interruption of an infra-red light grid arranged in front of the display. Therefore an infra-red touch-detection device and touch-recognition system contains a row of infra-red LEDs and phototransistors, each mounted on two opposite sides for creating a grid of invisible infra-red light. The frame assembly comprises the printed circuits, on which the electronic components are mounted, and it is hidden behind a protection glass transparent to infra-red lights.

The infra-red touch-control device pilots in sequence the LEDs with impulses modulated for creating a grid of rays of infra-red light and avoid that other light sources may interfere with the reading.

When a stylus, such as a finger, enters the grid, it obstructs the rays. One or more phototransistors detect the absence of light and transmit a signal which identifies the x and y coordinates. The position is translated by a suitable programme into a reading compatible with the operation of a common mouse.

Typically, the light grid is arranged so that a vertical solution is provided, as well as a guiding plate of the light which operates directly. This necessarily implies that the touch-control structure is very bulky, with evident limitations during the manufacturing step of new prototypes and new lines.

Moreover, in order for the control structure to be covered, the cover borders are particularly wide, thereby reducing the area available for the display.

Finally, the control structure thus accomplished is heavy, difficult to be managed in a mobile device.

Given the well-known need to reduce the size and weight of the frame and of the support structures in favour of a greater lightness and a greater width of the display, it is the object of the present invention to manufacture a mobile device with an infra-red touch-control device which is capable of guaranteeing greater versatility, greater lightness, a bulk as reduced as possible, in the light of an ever more precise touch sensitivity.

This object is achieved through a device of the type comprising a frame partly open on one of the planar surfaces, kept closed by a display module in association with an annular ornamental frame, which carries within the same infrared touch-detection electronic components, characterised in that said infra-red touch-detection electronic components consist of an infra-red board, provided along the upper perimeter surface with receiving and emitting LED lamps and with separate guiding means of the infra-red light arranged vertically, said guiding means consisting of a lower guiding frame of the infra-red light and of an upper guiding frame of the infra-red light.

Other preferred and advantageous features are defined in the set of dependent claims.

The invention and the properties thereof will be better defined by the following detailed description of a preferred embodiment, given purely as a non-limiting example and illustrated in the attached drawings, wherein:

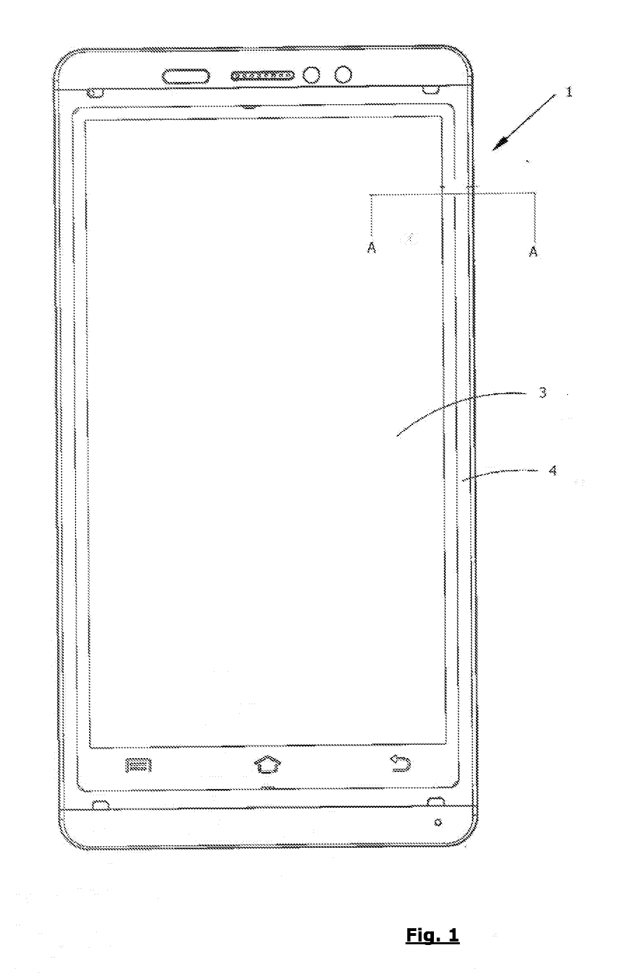

FIG. 1 shows a top plan view of the front surface of the mobile device according to the invention;

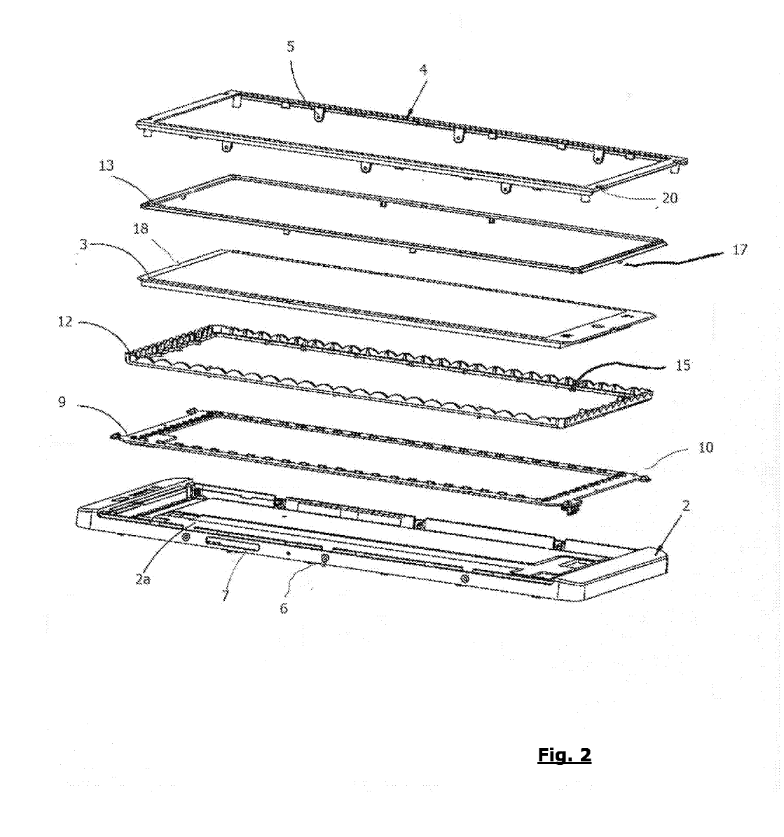

FIG. 2 shows an exploded view of the mobile device of FIG. 1

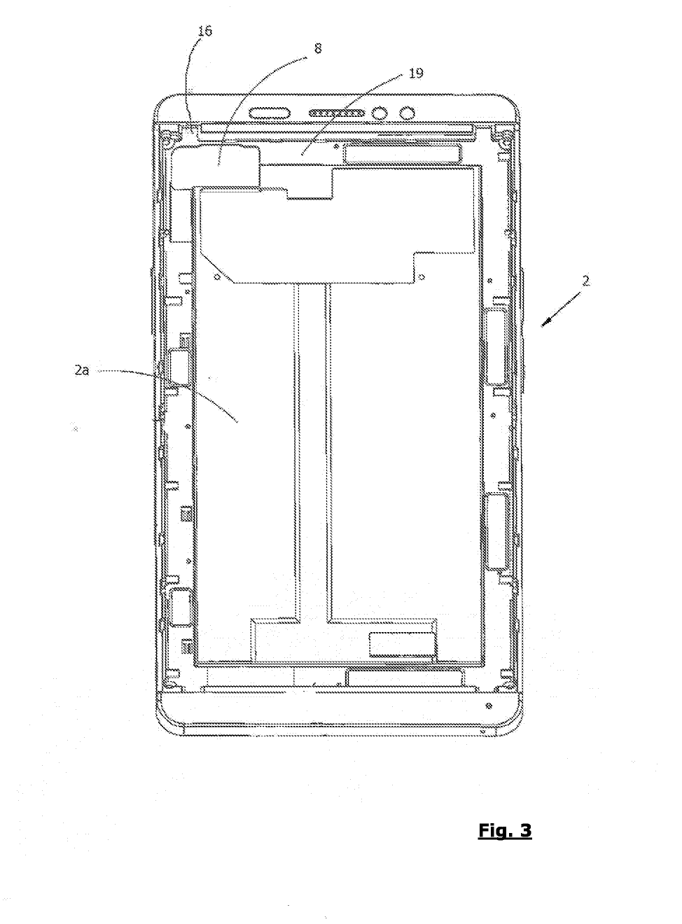

FIG. 3 is a top plan view of the frame of the mobile device of FIG. 1;

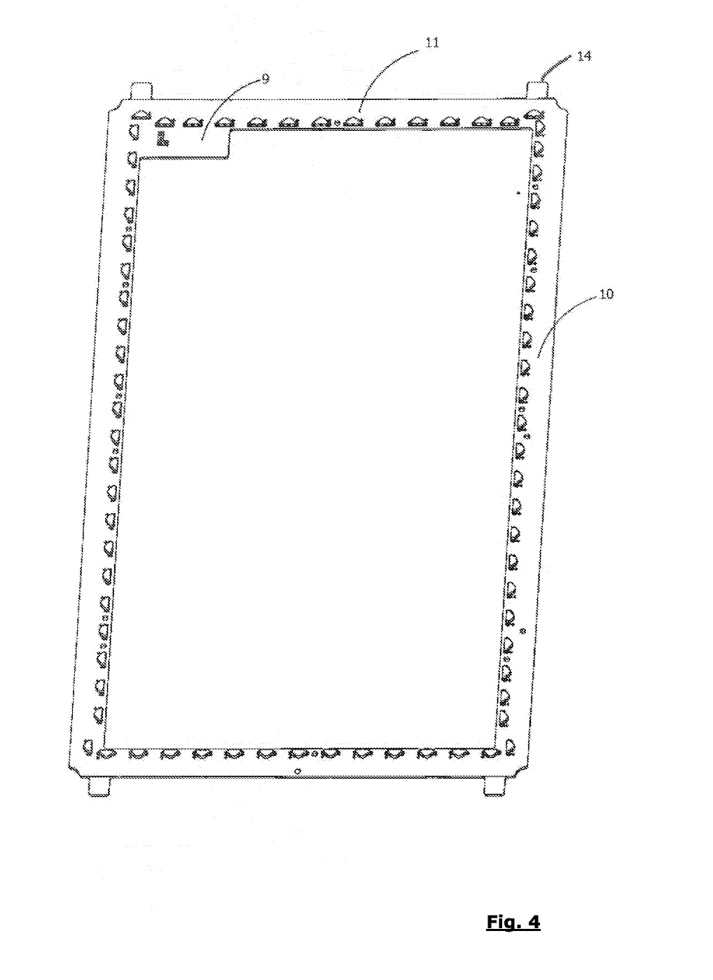

FIG. 4 is the bottom plan view of the lower guiding frame of the infra-red light of the telephone of FIG. 1; and

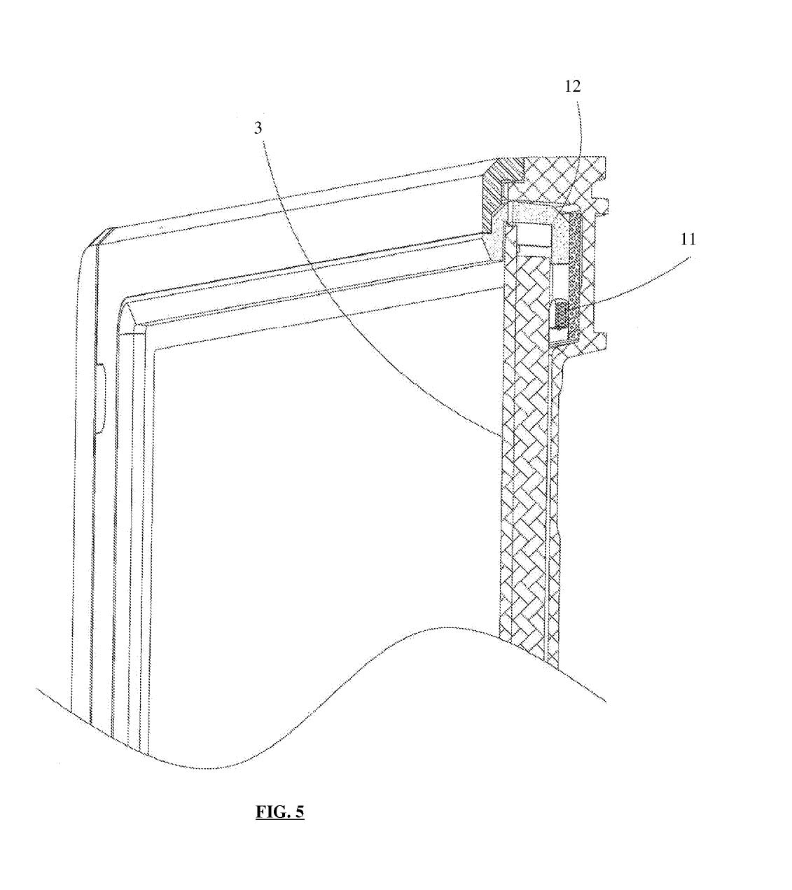

FIG. 5 is a cropped view of the cross section of the mobile device of FIG. 1 taken along the A-A line.

### DETAILED DESCRIPTION OF THE PREFERRED EMBODIMENT

The device according to the present invention consists of a substantially rectangular body 1 with rounded corners, conventionally consisting of a case 2 partly open on one of the planar surfaces, on the opening of which it is brought into engagement with closing a display module 3 kept in a steady position by an annular frame 4. In order to ensure sealing, the annular frame 4 provides below a series of connecting strips 5 connecting the same to the inner surface of the above-said case 2 in correspondence of threaded holes 6 arranged on the perimeter surface of said case 2. In the inner cavity 2a of said case 2 is housed the electronic component necessary for the operation of the device. Together with threaded holes 6 transversal slits 7 apt to receive memory cards or communication management cards are provided.

On the bottom surface of said cavity 2a in particular a housing and protection area 8 of a plate 9 of an integrated circuit (IC) for the management of an infra-red light board 10 is provided on the lower surface of which said plate 9 is mounted. Said infra-red light board 10 provides a continuous perimeter succession of infra-red LED lamps 11, which comprise emission lights and receiving lights. There are also provided several infra-red lights having circular layout.

In connection with said plate 9 a lower guiding frame 12 of the infra-red light is furthermore provided, arranged outside with respect to said succession 11 of LED lamps.

In order to make the device operative and allow the correct operation thereof an upper guiding frame 13 of the infra-red light between said display 3 and said annular frame 4 is furthermore provided.

For the correct anchoring of lower guiding frame 12 of the infra-red lights to case 2, two pairs of outwardly-protruding, opposite notches 14 are provided, as well as a series of inwardly-protruding, equidistantly-arranged engagement members 15.

Complementary to notches 14—as can be observed also from FIG. 1—are two pairs of grooves 16 of the short lateral surface of case 2; for the same purpose, engagement members 15 are carried in complementary cavities obtained on said cavity 2a of said case 2.

On upper guiding frame 13 of the infra-red light connecting members 17 are furthermore provided, apt to engage with grooves 18 provided along said display 3.

Furthermore, grooves 19 are provided in the cavity 2a of the case 2; these grooves 19 are placed around the infra-red light board 10 in order to increase the intensity of the infra-red light board 10 and prevent deformation thereof.

In order to obtain the infra-red detection network, the infra-red lights 11 are also provided under the display 3: in such a manner, the infra-red light emitted from the emission lights reflects to the upper guiding frame 13, through the light guide effect of the lower guiding frame 12. Then, the light is reflected by the upper guiding frame 13 in order to receive lights. In such a manner it is obtained a complete communication between the two guiding frames 12 and 13.

In the above infrared touch device 1, by separately placing upper guiding light 13 and lower guiding light 12, and independently assembling upper guiding light 13 and lower guiding light 12, two layers of guiding light module forming infrared light, display module 3 pressing the lower guiding light 12 and connecting strips 5 pressing the upper guiding light 13, this invention realizes the fixation of the upper guiding light 13 and lower guiding light 12 and reduces the set of the fixed structure to narrow the border size of the connecting strips 5, that means the border of the device can be made narrower and the size can be significantly reduced. Furthermore, the device can be widely applied to portable devices. Besides, the upper guiding light 13 and lower guiding light 12 are not affected by buckle or screw structure, and the flatness is high, the deformation does not affect the transmission of infrared, then the touch precision can be significantly improved.

In such a structure, upper guiding light 13 and lower guiding light 12 are mounted independently in case 2, they are pressed with the annular frame 4 and relevant connecting strips 5, connecting strips 5 are locking and fixing by side lock screws and bottom lock screws, it is easy and cheap to maintain and it can also make the structure of guiding light more steady. By connecting the annular frame 4 to upper guiding light 13 and connecting display module 3 to lower guiding light 12 to make the upper and lower levels connected, it can prevent lower guiding light 12 and upper guiding light 13 from deformation.

At last, in order to keep the annular frame 4 pressing on upper guiding light 13, and consequently keep the position both of the display 3 and the lower guiding light 12, onto the annular frame 4 are provided through holes 20, apt to house screw and other fasteners (not shown) that will add downward pressure to said annular frame and compress the upper guiding light 13.

The mounting of the device can be clearly understood from the preceding description. The operator inserts in sequence the lower guiding member taking care to bring the integrated circuit plate for the management of the infra-red light in correspondence of the housing area and sheath provided on the base. Subsequently he rests the crystal liquid display for the viewing and covering of the telephone on top of the lower guiding member and thereon the upper guiding member, taking care to correctly engage the engagement and retaining member of the various components, so as to obtain a compact structure. Finally, he arranges the closing and protection member so that it is in contact with the upper surface of the upper light guide. At this point the operator tightens by means of the screws frame 4 to case 2, so that the just described system maintains a stationary and steady position. The telephone is thus ready for switching on.

The device thus accomplished, which in actual fact provides for the separation of the two guiding frames 12 and 13 of the infrared light, defining two layers of guiding light modules which form infra-red light, allows to reduce the size and weight of the device and to remarkably increase the versatility thereof for various types of devices.

Furthermore, the two guiding frames 12 and 13 are assembled independently in case 2; the connection between the two frame is obtained by the annular ornamental frame 4. As a matter of fact, the connecting strips provided on the annular ornamental frame 4 are able to fix said ornamental frame 4, and the two guiding frames 12 and 13, to the case 2.

In such a way, the guiding infra-red system is easy and cheap to maintain; furthermore it can also make the structure of guiding light more steady.

The light signal is therefore transmitted between the two frames 12, 13 and through display 3 and is processed in infra-red light board 10. It must be pointed out that the guiding frames of infrared light are in no way touched by outer fastening members, thus allowing to increase touch-detection and touch-precision performances.

Moreover, the full independence between the two frames of infrared light must be appreciated.

Finally, it is wished to highlight the fact that in fact the use of fastening screws is provided exclusively on the outer perimeter surface of the device, for the fastening of the ornamental and sealing members of the device, all the other components being kept in position only by dap joint solutions.

It is clearly understood that the device thus structured and described perfectly accomplishes the set objects, that is, to obtain greater accuracy of touch control, substantial reduction of the telephone frame size and better operation of the infrared-based touch system.

Moreover, the device just described does not need any screw-based support and fastening structure which directly affects the upper and lower light guides, so as to avoid interferences in the acquisition of the touch movement on the display: as a matter of fact the light can propagate with no deformation whatsoever. As a matter of fact, the guides are mounted separately in the sheath and are kept compressed by the sheath decoration, which is kept fastened to the frame by suitable connecting strips (as described above).

Moreover, the special arrangement of the invention allows to block infra-red light, reducing the risk that it translates, and increases intensity, preventing infra-red from being deformed.

Finally, it should be underlined that the special arrangement of an upper guiding light frame and a lower guiding frame allows to reduce the lateral dimensions of the frame, increasing the area available for the display, in addition to reducing the telephone weight.

Resuming, the infrared touch device 1 that provided in this embodiment has a number of improvements shown as below:
upper guiding light 13 and lower guiding light 12 are assembled independently;
the fixing treatment of upper guiding light 13;
upper guiding light 13 and lower guiding light 12 are combined to give out infrared guide light;
upper guiding light 13 and lower guiding light 12′s respective treatment with display module 3;
upper guiding light 13 and lower guiding light 12′s anti-deformation treatment with display module 3; and
treatment technology of a housing and protection area of the plate of integrated circuit (IC) for the management of the infra-red light board.

It can be understood that in the preceding description no mention has been made of the members which allow the correct operation of the telephone, but which have no relevance for the better understanding of the invention. It is well understood that in the above described telephone all the conventional members for the power supply of the device and for being able to effect a telephone connection are anyhow present. The accessories can furthermore be provided which are by now habitually present in this kind of device.

However, it is understood that the invention must not be considered limited to the special arrangement illustrated above, which represents only an exemplifying embodiment thereof, but that different variants are possible, all within the reach of a person skilled in the field, without departing from the scope of the invention, as defined in the following claims.

1. Device of the type comprising a case (2) partially open on one of the planar surfaces, kept closed by a display module (3) in association with an annular ornamental frame (4) which carries within infra-red electronic components for touch detection, wherein said infra-red electronic components for touch detection consist of an infra-red plate (10), provided along the upper perimeter surface with receiving and emitting LED lamps (11) and with separate guiding means of the infra-red light arranged vertically, said guiding means consisting of a lower guiding frame (12) of the infra-red light and with an infra-red upper guiding frame (13).

2. Device as claimed in claim 1), wherein said display (3) is arranged between said lower infra-red guiding frame (12) and said upper infra-red guiding frame (13).

3. Device as claimed in claim 1), wherein on the lower surface of said infrared plate (10) an integrated-circuit plate (9) for the management of said board is mounted.

4. Device as claimed in claim 3), characterised in that wherein said lower infra-red guiding frame (12) is arranged externally with respect to said sequence of infra-red LED lamps (11).

5. Device as claimed in claim 1 wherein said infra-red LED lamps (11) are also provided under said display module (3).

6. Device as claimed in claim 1, wherein said lower infra-red guiding frame (12) is kept in position with respect to the case (2) by the engagement between two pairs of outward-projecting notches (14) arranged on the short sides of said case (2) and two pairs of grooves (16) complementary therewith provided on the inner lateral surface of said case (2).

7. Device as claimed in claim 1, wherein evenly-arranged, inward-projecting engagement members (15) are furthermore provided, with which cavities obtained on said cavity (2a) of said case (2) are complementary.

8. Device as claimed in claim 6), wherein on said upper infra-red guiding frame (13) connecting members are furthermore provided apt to engage with grooves provided along said display (13).

9. Device as claimed in claim 1, wherein said annular frame (4) associated with said display (3) provides threaded connecting strips (5) for the engagement with screws to be inserted through threaded holes (6) provided along the lateral walls of the case (2).
